(19) United States
(12) Patent Application Publication
(10) Pub. No.: US 2008/0162555 A1
(43) Pub. Date: Jul. 3, 2008

(54) ACTIVE LIFESTYLE MANAGEMENT

(75) Inventors: Francesca Schuler, Des Plaines, IL (US); Krishna D. Jonnalagadda, Algonquin, IL (US); Janice M. Danvir, Arlington Heights, IL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/616,636

(22) Filed: Dec. 27, 2006

(51) Int. Cl. G06F 7/00

(52) U.S. Cl. 707/104.1

(57) ABSTRACT

A method, wireless communication device, and information processing system are provided for monitoring lifestyle activities. The method includes receiving a set of user activity identifiers associated with a set of user activities (804). At least one sensor assigned to each user activity in the set of user activities is identified (1004). At least one user activity context is associated with each user activity in the set of user activities (810). The method also includes monitoring for an occurrence of the at least one user activity context (822). Based on the monitoring, it is determined whether the at least one user activity context has occurred (822). Each sensor (122) assigned to the user activity associated with the at least one user activity context is monitored in response to the at least one user activity context having occurred (1006).

### CROSS-REFERENCE TO RELATED APPLICATIONS

This application is related to applications entitled “Monitoring For Radio Frequency Enabled Items Based On Activity Profiles,” U.S. patent application Ser. No. ______, Attorney Docket No. CML03855T, and “Dynamic Updating Of Product Profiles For Active Lifestyles”, U.S. patent application Ser. No. ______, Attorney Docket No. CML04599T, which were filed on the same day as the present application and commonly assigned herewith to Motorola, Inc. These related applications are incorporated herein by reference in their entirety.

### FIELD OF THE INVENTION

The present invention generally relates to the field of wireless communication devices, and more particularly relates dynamically managing lifestyle activities via the wireless communication device.

### BACKGROUND OF THE INVENTION

Wireless communication devices have evolved greatly over the past years. For example, current wireless communication devices can browse the Internet and play audio files among other things. As technology develops users will demand more from their wireless devices. For example, users may want their wireless device to be a lifestyle management hub, where lifestyle activities such as work, meetings, running, and the like are monitored and managed. However, current wireless communication devices only offer a calendar feature for organizing time and dates.

If a user desires to track certain items such as running shoes associated with an activity such as “jogging”, a user has to use a traditional RFID tracking system. Radio frequency identification (“RFID”) is used to automatically identify and track RFID enabled items. However, current RFID systems are not context based and constantly monitor for items. This not efficient for a wireless communication device where battery life is a valued resource.

Furthermore, user may want the wireless communication device to monitor devices and/or sensors associated with a lifestyle activity. For example, a user may want to use a biometric, physiological, or location monitor during a lifestyle activity. However, current wireless communication devices are not capable of managing and/or monitoring such devices based on an activity context. For example, with current wireless communication devices a user has to manually initialize a sensor and manually execute an application on the device. This fails to provide a seamless environment for the user.

An additional problem with current RFID systems is that they do not provide sensor/RFID selectivity based on activity/context when multiple sensors are available for various activities. Users do not want to have to manage sensor/initialization/termination, etc. (i.e. not all sensors are needed all of the time, for every activity). Current RFID systems have a disadvantage of long set up times for users and do not provide individualized data collection. If all sensors are used all of the time redundant/unnecessary data can result in current RFID system. This can result in inefficient use of the wireless device's processing/power usage.

Therefore a need exists to overcome the problems with the prior art as discussed above.

### SUMMARY OF THE INVENTION

Briefly, in accordance with the present invention, disclosed are a method, a communication device, and an information processing system for monitoring lifestyle activities. The method includes receiving a set of user activity identifiers associated with a set of user activities. At least one sensor assigned to each user activity in the set of user activities is identified. At least one user activity context is associated with each user activity in the set of user activities. The method also includes monitoring for an occurrence of the at least one user activity context. Based on the monitoring, it is determined whether the at least one user activity context has occurred. Each sensor assigned to the user activity associated with the at least one user activity context is monitored in response to the at least one user activity context having occurred.

In another embodiment, a wireless communication device is disclosed. The wireless communication device includes a memory and a processor that is communicatively coupled to the memory. The wireless communication device also includes a dynamic activity manager that is communicatively coupled to the memory and the processor. The dynamic activity manager is for receiving a set of user activity identifiers associated with a set of user activities. At least one sensor assigned to each user activity in the set of user activities is identified. At least one user activity context is associated with each user activity in the set of user activities. The dynamic activity manager is also for monitoring for an occurrence of the at least one user activity context. Based on the monitoring, it is determined whether the at least one user activity context has occurred. Each sensor assigned to the user activity associated with the at least one user activity context is monitored in response to the at least one user activity context having occurred.

In yet another embodiment, an information processing system for monitoring lifestyle activities. The information processing system includes a memory and a processor that is communicatively coupled to the memory. The information processing system also includes a dynamic activity manager that is communicatively coupled to the memory and the processor. The dynamic activity manager is for receiving a set of user activity identifiers associated with a set of user activities. At least one sensor assigned to each user activity in the set of user activities is identified. At least one user activity context is associated with each user activity in the set of user activities. The dynamic activity manager is also for monitoring for an occurrence of the at least one user activity context. Based on the monitoring, it is determined whether the at least one user activity context has occurred. Each sensor assigned to the user activity associated with the at least one user activity context is monitored in response to the at least one user activity context having occurred.

The method includes receiving a set of user activity identifiers associated with a set of user activities. At least one sensor assigned to each user activity in the set of user activities is identified. At least one user activity context is associated with each user activity in the set of user activities. The method also includes monitoring for an occurrence of the at least one user activity context. Based on the monitoring, it is determined whether the at least one user activity context has occurred. Each sensor assigned to the user activity associated with the at least one user activity context is monitored in response to the at least one user activity context having occurred.

One of the advantages of the present invention is that a lifestyle activity management environment is provided to a user on a wireless communication device. For example, a wireless communication device of the present invention is able to monitor and manage a lifestyle activity based on its associated content such as a time or location context. The lifestyle activity manager of the present invention is able to track items such as running shoes and collect data from sensors associated with the activity. The items and sensors can be managed/monitored based on contexts such as time, location, activity, weather and the like thereby creating a dynamic lifestyle activity manager. For example, a pedometer on a pair of shoes does not have to be turned on for a cycling activity.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating wireless communications system according to an embodiment of the present invention;

FIG. 2 shows a detailed view of a Dynamic Activity Manager according to an embodiment of the present invention;

FIG. 3 shows an exemplary user interface for an activity management application according to an embodiment of the present invention;

FIG. 4 shows an exemplary user calendar and activity profiles according to an embodiment of the present invention;

FIG. 5 is a timing diagram illustrating one example of monitoring an activity based on one or more contexts according to an embodiment of the present invention;

FIG. 6 is a block diagram illustrating a wireless communication device according to an embodiment of the present invention;

FIG. 7 is a block diagram illustrating a information processing system according to an embodiment of the present invention;

FIG. 8 is an operational flow diagram illustrating a process of associating one or more contexts with an activity according to an embodiment of the present invention; and

FIGS. 9-11 are operational flow diagrams illustrating a process of managing and monitoring an activity based on one or more contexts associated with the activity according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communications System

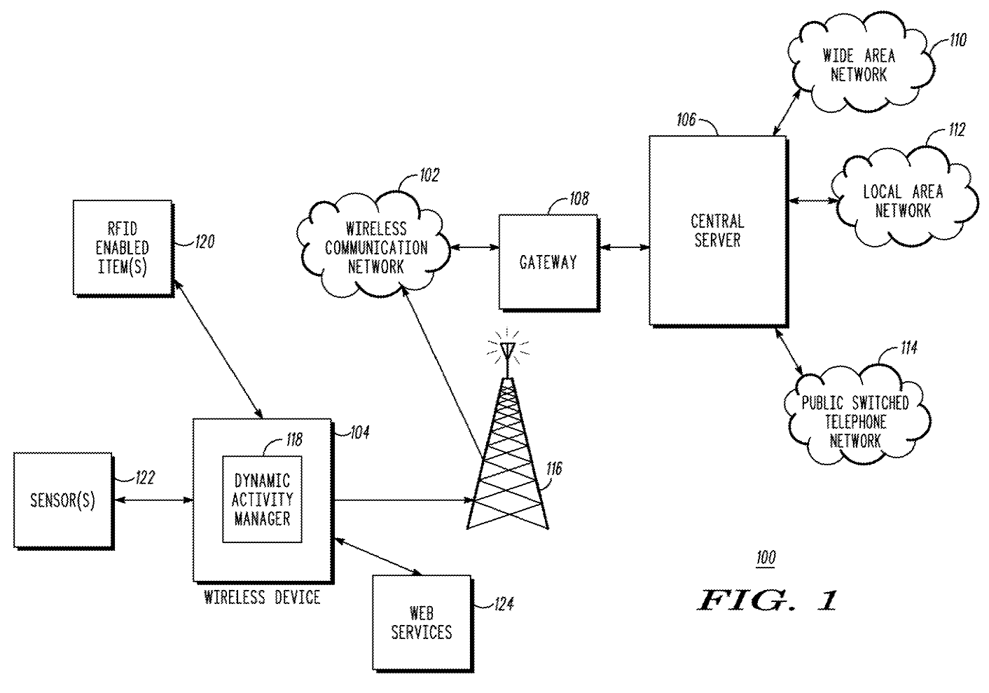

FIG. 1 illustrates one example of a wireless communications system 100 according to an embodiment of the present invention. FIG. 1 shows a wireless communications network 102 that connects one or more wireless devices 104 with a central server 106 via a gateway 108. The wireless communications network 102 comprises a mobile phone network, a mobile text messaging device network, a pager network, or the like. Further, the communications standard of the wireless communications network 102 comprises Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), Orthogonal Frequency Division Multiplexing (“OFDM”), or the like. Additionally, the wireless communications network 102 also comprises text messaging standards, for example, Short Message Service (“SMS”), Enhanced Messaging Service (“EMS”), Multimedia Messaging Service (“MMS”), or the like.

The wireless communications network 102 supports any number of wireless communication devices 104. The support of the wireless communications network 102 includes support for mobile telephones, smart phones, text messaging devices, handheld computers, pagers, beepers, wireless communication cards, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, wireless communication cards (not shown) reside within an information processing system (not shown). The information processing system (not shown), in one embodiment, can be a personal computer, a personal, digital assistant, a smart phone, and the like.

Additionally, the wireless device 104 can also include a local wireless link (not shown) that allows the wireless devices 104 to directly communicate with another wireless device without using the wireless network 102. The local wireless link (not shown), for example, is for allowing PTT communications. The local wireless link (not shown), in another embodiment, is provided by Bluetooth, Infrared Data Access (IrDA) technologies or the like. The central server 106 maintains and processes information for all wireless devices communicating on the wireless network 102.

Additionally, the central server 106, in this example, communicatively couples the wireless device 104 to a wide area network 110, a local area network 112, and a public switched telephone network 114 through the wireless communications network 102. Each of these networks 110, 112, 114 has the capability of sending data, for example, a multimedia text message to the wireless device 104 The wireless communications system 100 also includes one or more base stations 116.

The wireless device 104, in one embodiment, includes a dynamic activity manager 118 for managing lifestyle activities of the user. The dynamic activity manager 118 can associate one or more contexts such as time, location, and the like to an activity entered by a user. The dynamic activity manager 118 also manages an activity and any device or item associated with the activity. FIG. 1 shows the wireless device 104 communicatively coupled to one or more RFID enabled items 120, sensors 122, and web services 124.

An RFID enabled item 120 is any item such as a gym bag, wallet, file, shoes, skis, and the like that is coupled to an RFID tag. A sensor 122, in one embodiment, can be a lifestyle sensor. For example, the sensor 122 can be a physiological sensor such as a heart rate sensor, body temperature sensor, caloric sensor, or the like. Another example of a sensor is a pedometer. It should be noted that any sensor or device capable of taking measurements is applicable to the present invention. These sensors can be embedded, for example, in clothing and/shoes or can be stand-alone items. One specific example of these types of sensors is a sensor that is embedded in running shoes. As a user walks or runs, the sensor 122 monitors various functions such as speed, stride length, body functions (heart rate, temperatures, hydration, and the like), and the like.

This information can then be relayed back to the dynamic activity manager 118 if desired. A web service 124 can be any type of service subscribed to by the user over the Internet. For example, a user can be subscribed to a weather service that is used by the dynamic activity manager 118 when monitoring an activity such as running. The dynamic activity manager 118, RFID enabled items 120, sensors 122, and web services 124 are discussed in greater detail below.

Dynamic Activity Manager

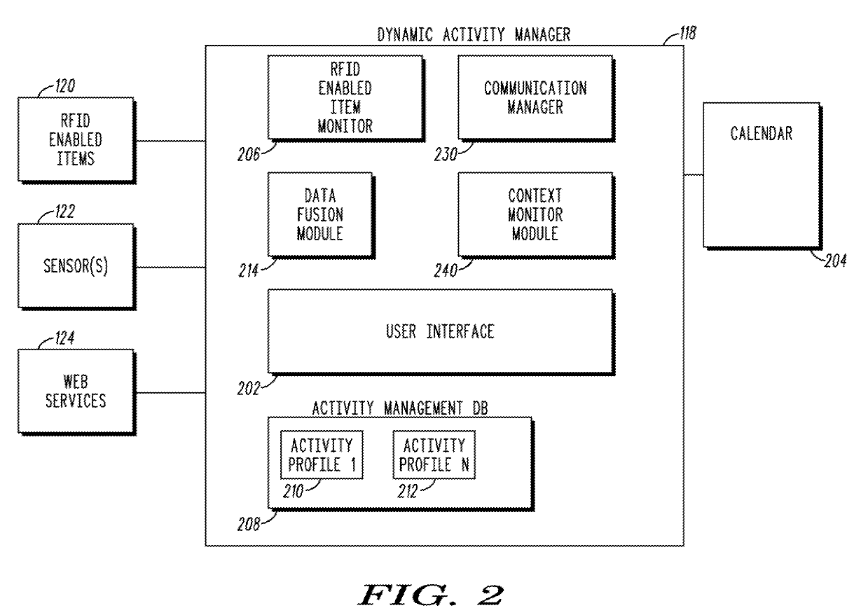

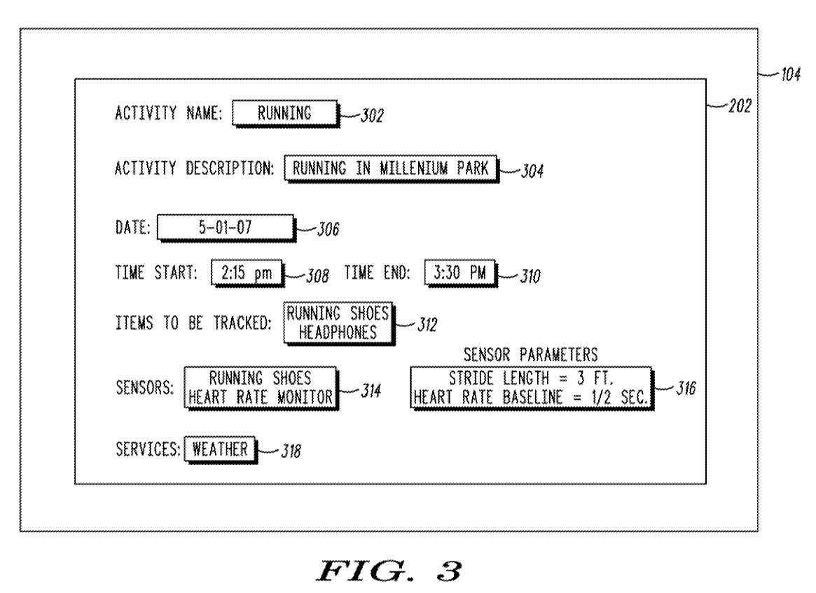

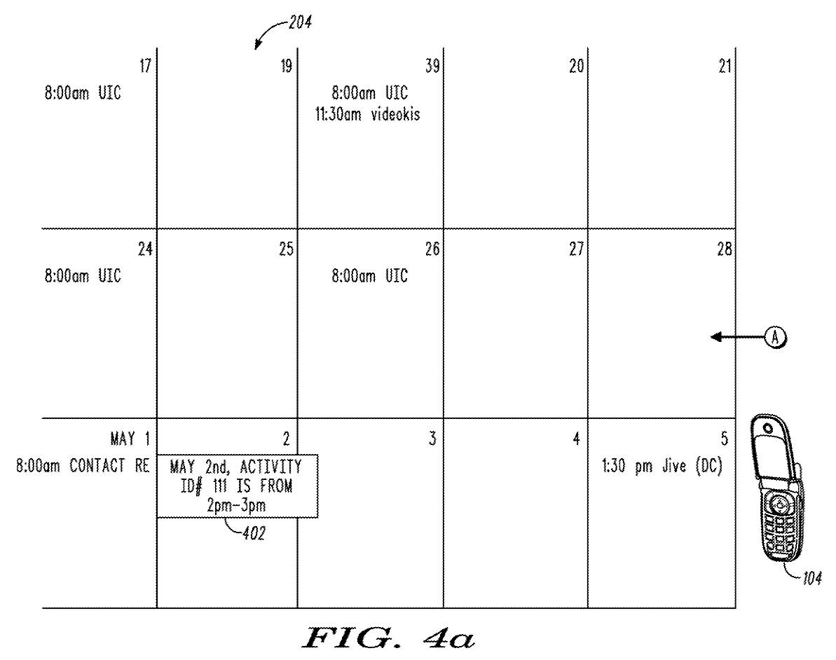

FIG. 2 shows a more detailed view of the dynamic activity manager 118. The dynamic activity manager 118 provides a dynamic management system for monitoring and managing user lifestyle activities. The activity manager 118, in one embodiment, includes a user interface 202, for allowing a user to enter information associated with an activity that the user wants managed and/or monitored. For example, FIG. 3 shows one example of the user interface 202 being displayed on the wireless device 104. It should be noted that some fields can be automatically populated based on user activity entry, activity history, rules, or the like.

FIG. 3 shows an activity name entry field 302 that allows the user to enter the name of an existing activity or the field 302 can be a drop down box including existing activities. FIG. 3 shows that a user has entered the activity of “running”. Therefore, the user is configuring the activity manager 118 to manage and monitor a running activity. The user interface 202 can also include an activity description field 304, which allows a user to enter a description of the activity. A date entry field 306 is also included on the user interface 202. The date field 306 allows a user to enter the date or dates when the activity is to occur. A time start field 308 and an end time field 310 are also provided in the user interface 202. The start time field 308 indicates when the activity begins and the end time field 310 indicates when the activity ends.

A user may also want the activity manager 118 to track specific items associated with the activity. For example, with respect to the running activity, a user may want to have her running shoes and headphones tracked to ensure that she has these items when she begins the activity. This information can be entered in the items to be tracked field 312. The tracking process is discussed in further detail below. The user may also want to use specific sensors during the activity such as sensors in the running shoes and a heart rate monitor. The sensor IDs or names can be added into the sensor field 314. A user can also configure the sensor parameters that she wants used during the activity. Alternatively, the sensor parameters can be transparent to a user. For example, the parameters can be pre-populated based on success of data collection of prior activity history. This information is entered in a sensor parameter field 316. In addition to having items tracked and sensors monitored during the activity, the user may want to associate a web service with the activity.

For example, a user may want to associate a weather service with the running activity so that the activity manager 118 can automatically and dynamically adjust settings on the sensors; determine to track different items; and the like. For example, the activity manager 118 can monitor the web service to determine if the weather is sunny, cloudy, raining, or the like. If the weather is sunny, the activity manager may determine that a first pair of running shoes, sun glasses, and the like need to be tracked. On the other hand, if the weather is raining, the activity manager 118 can determine not to track sunglasses and to track a second pair of running shoes. It should be noted that the term “tracked” as used throughout this discussion refers to determining the present or lack thereof of an RFID enabled item 120.

Alternatively, a user can setup rules that allow a web service to perform a function based on contexts. For example, if the weather is rainy, a user can have a rule setup that has a web service make a reservation at an indoor track. FIG. 3 also shows a web sensor rule(s) entry field 320. The web service field 320 allows a user to enter various rules associated with web services. For example, a user can setup a web service via the web service rules field 320 to reserve a running track if the temperature outside is less than 60° F. or if it is raining.

It should also be noted that the user interface of FIG. 3 is only one example of a user interface applicable to the present invention. One or more fields may be added or deleted. For example, the user interface 118 can also provide a mechanism to a user for reviewing all entered activities, deleting activities, and the like. It should also be noted that the user interface 202 can also reside on an information processing system coupled to the wireless device 104. For example, the activity manager 118 can have software loaded on a personal computer that allows the user to enter the above information or to interact with the activity manger 118. The activity manager 118 can then sync with the software on the information processing system to update its data. In yet another embodiment, a user can enter information directly at an RFID enabled item 120 or a sensor 122. For example, a sensor 122 can include a user interface with a calendar. Any information entered here can then be synced with the activity manager 116. Any configuration parameters such as a heart rate baseline, stride length, and the like are then communicated to the activity manager 118.

Returning back to FIG. 2, the information received from a user, for example, via the user interface 202 can also be provided to a calendar 204 residing within the wireless device 104. Alternatively, information from the calendar 204 can also be extracted by the activity manager 118. For example, if the activity manager 118 determines that a user has entered a new activity in the calendar 204, the activity manager 118 can prompt the user to determine if the user wants the activity manager 118 to monitor and manage that activity. Although shown residing outside of the activity manager 118, the activity manager 118 can include an internal calendar for monitoring lifestyle activities. In other words, the wireless device 104 can include a calendar and the activity manager 118 can also include an internal calendar used in conjunction with the wireless device calendar 204.

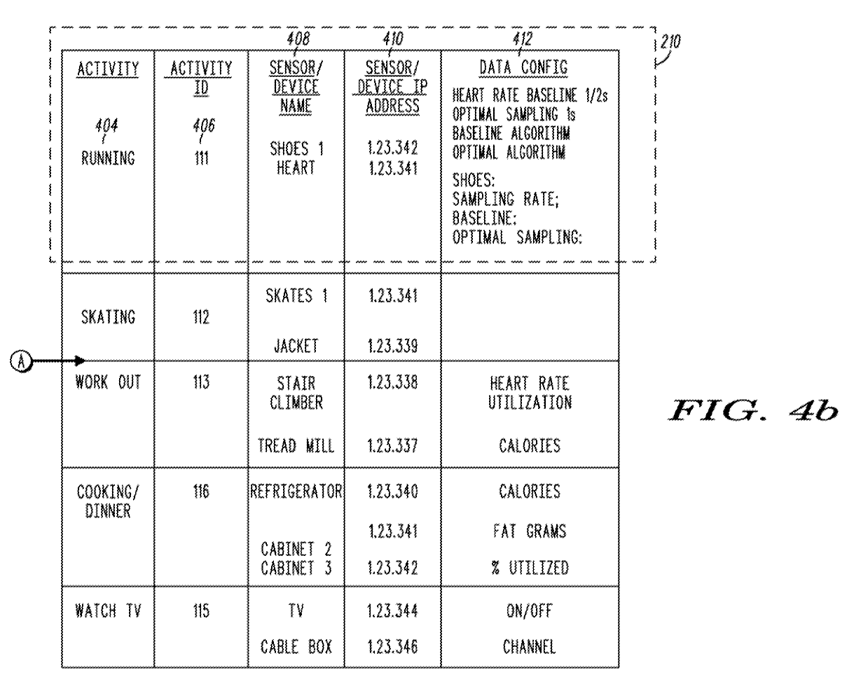

Based upon the received activity information, the activity manager 118 creates activity profiles 210, 212 that are stored in an activity management database 208. FIG. 4 shows an example of an activity profile 210 for a variety of activities. Although FIG. 4 shows a single table that includes multiple activities, each activity can be stored within a separate activity profile. FIG. 4 also shows a calendar 204 comprising calendar events associated with an activity. The activity profile 210 includes various information associated with an activity such as a name 404 of an activity, an activity ID 406, a sensor or device name 408 associated with the activity, a RFID/device IP address 410 if available, data configuration 412 for the sensor/device and the like.

Also, FIG. 4 shows web services 414 and web service rules 416 associated with a web service. For example, a web service A is associated with the “running” activity. A web service rule is associated with the web service A that indicates that if the temperature outside is less than 60° F. then reserve an indoor track. As can be seen, the activity profile associates a sensor/device context with activity. The sensor/device context indicates what sensors/devices or associated with the activity and their current configurations.

In the example of FIG. 4, the information within the activity profile 210 is independent of a time context or location context associated with an activity. In one embodiment, the calendar 204 associates a time context with and activity and an optional location context. For example, FIG. 4 shows a calendar event 402 set for May 2^{nd} with a “running” activity from 2 p.m. to 3 p.m. The calendar 204 can also show the location of the activity such as “Millennium Park”. Therefore, the “running” activity has a time context and a location context associated with it. The information within the activity profile 210 can be used by the activity manager 118 regardless of the time and location contexts.

For example, if the user has defined a “running” activity on two different days at two different times and at two different locations, the activity manager 118 can still refer to the “running” activity profile and use the information included therein for the two instances of the “running” activity. Therefore, the activity manger 118 monitors both the calendar 402 and the activity management database 208. However, the activity profiles 210 can also include time and location contexts as well. In this example, a separate activity profile is stored in the activity management database for each instance of an activity.

Returning now to FIG. 2, the activity manager 118 also includes a context monitoring module 210. In one embodiment, the content monitoring module 210 allows the activity manager to determine whether an activity is about to start, has started, or has ended and either monitor for RFID enabled items 120 and/or initialize sensors 122 associated with the activity. For example, the context monitoring module 210 monitors context such as time, location, device, and the like. The context monitoring module 210 can monitor the calendar 204, GPS, or information entered by the user to determine the current and/or location of the wireless device. The activity manager 118 can compare activity profiles and/or calendar events with the determined time and/or location to determine whether an activity is starting, ending, or the like.

In one embodiment, the dynamic activity manager 118 is communicatively coupled to a GPS module 246 and a display 244. The GPS module can be used by the dynamic activity manager 118 to determine the location of the wireless device 104. The display 244 can be used for, among other things, to display data/information, visual alerts to a user.

As discussed above, the activity manager 118 manages and monitors RFID enabled items 120, sensors 122, and web services 124 associated with a user activity. RFID enabled items 120 can be any item that is coupled to an RFID tag. The activity manager 118 monitors RFID enabled items 120 via an RFID enabled item monitor 206, herein referred to as the “RFID monitor” 206. The RFID monitor 206, in one embodiment, can be a RFID transceiver embedded with monitoring software or can be a separate monitoring software module coupled to an RFID transceiver.

The RFID monitor 206 can be configured by the user to automatically start monitoring for items associated with an activity or to continuously monitor for RFID enabled items 120. For example, when the activity manager determines, based on a time context and/or a location context associated with an activity, that it is time for an activity to start, the activity manager 118 can begin monitoring for associated RFID enabled items 120. For example, if the activity manager 118 determines that the running activity is about to begin, the RFID monitor analyzes the activity profile 210 to determine what items are needed for the activity. The RFID monitor 206 then determines if items such as running shoes and heart beat monitor are present. In other words, the RFID monitor 206 determines if an RFID signal from the running shoes and the heartbeat monitor has been detected. The activity manager 118 can then visually, audibly, and/or tactilly notify the user of the presence or non-presence of the items 120.

In one embodiment, the RFID monitor 206 can be configured to start monitoring at a time interval before the activity begins. This gives a user enough time to locate any missing items. Alternatively, the activity manager 118 can be location aware either by GPS, RFID sensing, of the like and start monitoring for RFID enabled items 120 based on location. For example, a user can have RFID sensors and/or readers within his/her house. The activity manager 118 can determine that the wireless device 104 is within the user's house based on identifying the RFID sensors. Alternatively, the activity manager 118 can determine that the wireless device is within the user's house via an indoor positioning system or GPS if a strong enough signal is being received.

Based on the activity profiles 210, calendar 204, and/or an internal clock the activity manager 118 can determine that the user has not left for work, to go running, or whatever the activity may be. For example, a user can have a calendar entry or an activity defined for “leave for work”, which begins at 8:00 a.m. Therefore, if the time is 7:30 a.m. the activity manager 118 can determine that the user has not left for work. In another example, a user can have an activity defined for “running”. The activity manager 118 can detect that the user has left the house, entered his/her car, or the like either by passing an RFID sensor at a door or via GPS and analyzes the activity profiles 210 accordingly.

The activity manager 118, based on activity profiles and/or calendar events determines that the user is going straight from work to her running activity. Therefore, the activity manager 118 monitors for the items associated with the running activity. The activity manager 118 then notifies the user if these items have been protected. A more detailed discussion of tracking RFID enabled items is further discussed in the co-pending and commonly owned U.S. patent application Ser. No. ______, filed ______, and entitled “Monitoring For Radio Frequency Enabled Items Based On Activity Profiles”, which is hereby incorporated by reference in its entirety.

In addition to monitoring for associated RFID enabled items 120 when an activity is to begin, the activity manager 118 manages sensors 122 associated with the activity. For example, when an activity is about to begin, the activity manager 118 analyzes the activity profile 210 associated with the activity and identifies the sensors 122 associated with the activity. If the sensor 122 has not been initialized, the activity manager 118 initializes the sensor 122 using the configuration parameters in the activity profile 210. For example, the sensors 122 and the wireless device 104 can communicate via a communication manager 212 within the activity manager 118. The sensors 122 and the wireless device 104 can communicate using a wireless connection such as Bluetooth, Zigbee, or the like. In one embodiment, the dynamic activity manager also includes a data fusion module 214 for performing data fusion with respect to health and fitness information monitored by the sensors 122.

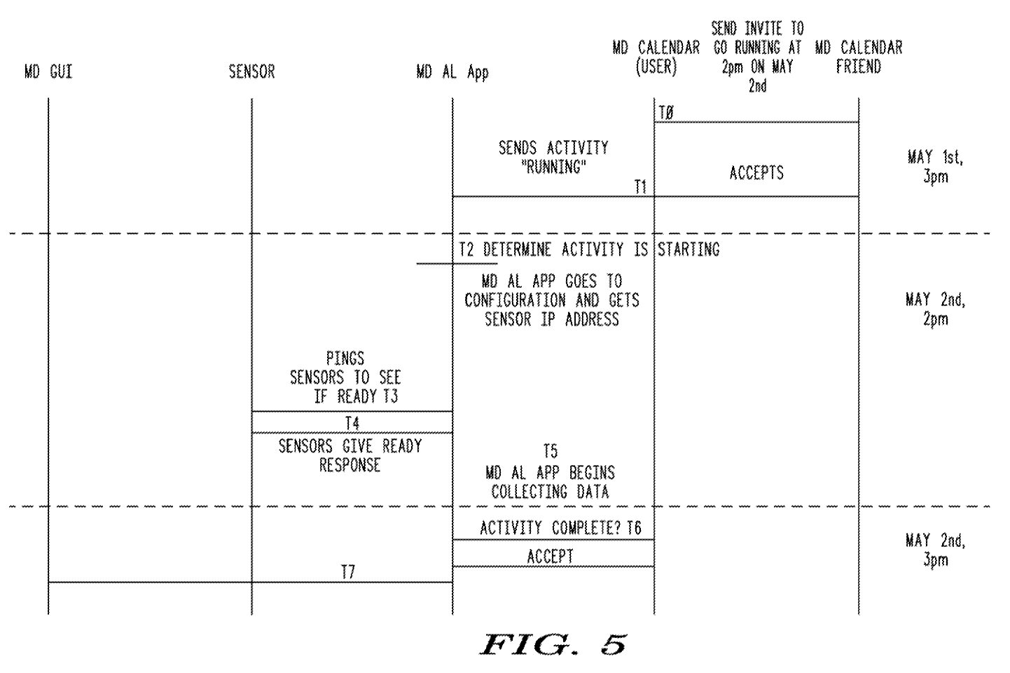

FIG. 5 shows a timing diagram for one example of initializing a sensor 122 based on the activity manager 118 detecting the start of an activity. In the example of FIG. 5, a user has a “running” activity defined on the user's wireless device 104 and wants to invite a friend to the activity. At time T₀ the activity manager 118 sends an invite associated with the “running” activity to another wireless device. The invite includes the time context, e.g., May 2^{nd} at 2 p.m., and can include an optional location context. At time T₁ the invitee wireless device sends an acceptance message to user's wireless device 104. At time T₂, the activity manager 118 determines that the time is 2:00 p.m. and queries the activity management database 208 to identify the sensors 122 associated with the “running” activity. The activity manager 118 also obtains the IP address of the sensor(s) 122. The IP address is used by the communication manager 212 to communicate with the sensor 122. In one example, the sensors 122 associated with the running activity are a sensor within running shoes that measures average speed, distance traveled, and the like. Another sensor can be a hear rate monitor worn in the wrist or an audio headset of the user.

At time T₃ the activity manager 118 pings the sensors 122 to determine if they have been initialized. If the sensors 122 have not been initialized the activity manager 118 identifies that configurations parameters of the sensor from the activity profile 210 and initializes the sensors 122 accordingly. The sensors 122, at time T₄, send a ready response to the activity manager 118. At time T₅ the activity manager 118 begins collecting data from the sensors 122. The activity manager 118, at time T₆, determines that the activity has completed. At time T₇, the activity manager118 displays collected data from the sensors 122 to the user via the user interface 202.

In another embodiment, a user can configure the activity manager 118 to only collect specific data from a sensor 122 or not all data. Also, the activity manager 118 does not have to communicate with a sensor 122 during an activity. For example, a user may have forgotten the wireless device 104 at her house. The application manager 118 determines that an activity is starting, but sensors 122 are not in the vicinity. When sensors 122 come back into range with the wireless device 104, e.g., the user comes home from running, the activity manager 118 queries the sensor 122 for the data collected during the activity. In one example, the sensors 122 collect data continuously and in another example the sensor 122 only collects data during scheduled activities. For example, a user's watch may have a biometric sensor that collects data throughout the day. However, the user may only be concerned with plotting data during athletic activities such as bicycling. Therefore, the activity manager 118 can query the sensor 122 for data only collected during a bicycling activity. In the above embodiments, the sensors include memory for storing data.

Returning back to FIG. 2, the activity manager118 can also monitor and manage web services 124 associated with an activity. For example, a user can define rules associated with web services 124 that are to be applied to the activity manager 118 with respect to an activity. One example is where a user subscribes to a weather service. The user can define a rule that states if the weather is rainy during the time period associated with an activity, then delay any monitoring or managing for that activity for 1 hour. Another rule can state to delay any managing or monitoring until a user prompt is received. The activity manager 118 can query the web service 124 at the start or prior to an activity starting to obtain the required information.

The activity manager 118 can also make dynamic decisions for when to monitor and/or manage an activity. For example, a user has an activity defined for “pick up dry-cleaning” at 3:00 p.m. However, at 12:00 p.m. the user runs errands and is approaching the dry cleaners. The activity manager 118 can detect the location of the user via GPS and determines that the user is near the dry cleaners. The activity manager then determines that the user needs to pick up the dry cleaning and prompts the user to pick up the dry cleaning even though the time is prior to the 3:00 p.m. scheduled pickup time.

Therefore, as can be seen from the above discussion, the present invention provides a lifestyle activity management system. The present invention associates various contexts such as time and location contexts to activities. Based on these contexts, the activity management system determines when an activity begins and starts monitoring for items associated with activity. The user is notified whether associated items are present or missing. Additionally, if a user has associated lifestyle sensors with an activity these sensors are initialized if needed and their data is collected. The present invention can selectively track items based on given activities as compared to current tracking systems that need to track all items at all times. Furthermore, the present invention is also advantageous because it provides selectability with respect to sensors. A user can choose which sensors are to be used. In other words, every sensor does not have to be on at all times, which provides efficient usage of the resources in a wireless device. Also, a management system is provided for managing the sensors.

It should be noted that the any of the above activity management operations discussed above can be performed at an information processing system such as the central server 106. For example, the wireless device 104 can provide an interface to the activity manager 118 to a user that resides on the central server 106. The activity manager 118 can also reside on an information processing system such as a personal computer, workstation, mobile device, or the like.

Wireless Communication Device

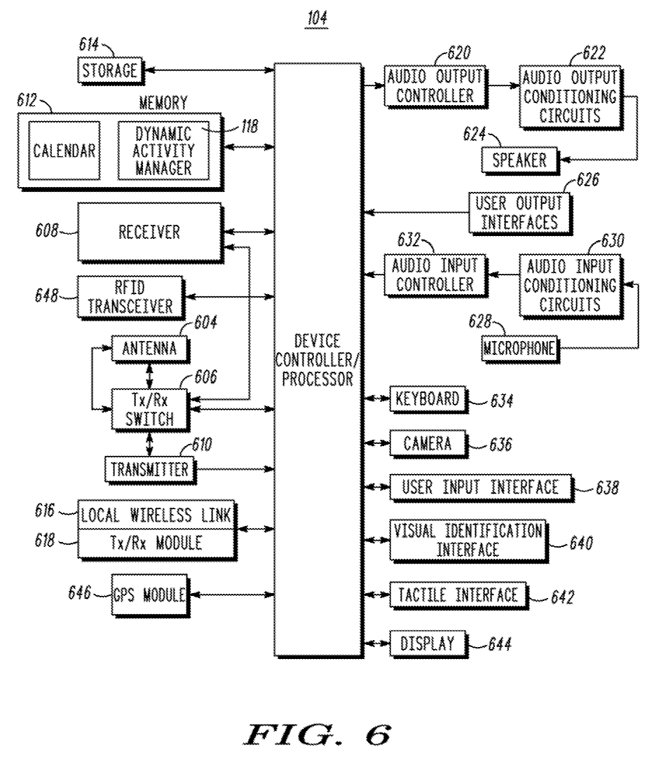

FIG. 6 is a block diagram illustrating a detailed view of the wireless device 104 according to an embodiment of the present invention. The wireless device 104 operates under the control of a device controller/processor 602, that controls the sending and receiving of wireless communication signals. In receive mode, the device controller 602 electrically couples an antenna 604 through a transmit/receive switch 606 to a receiver 608. The receiver 608 decodes the received signals and provides those decoded signals to the device controller 602.

In transmit mode, the device controller 602 electrically couples the antenna 604, through the transmit/receive switch 606, to a transmitter 610. The device controller 602 operates the transmitter and receiver according to instructions stored in the memory 612. These instructions include, for example, a neighbor cell measurement-scheduling algorithm. The memory 612, in one embodiment, also includes activity manager 118, and a calendar application 204 discussed above. It should be understood that the speech responsive search engine 118 shown in FIG. 6 also includes one or more of the components discussed in detail with respect to FIG. 2. These components have not been shown in FIG. 6 for simplicity.

The wireless device 104, in one embodiment, also includes an RFID transceiver 648 for communicating with RFID enabled items 120. In another embodiment, the receiver 608 is capable of receiving RFID signals. The wireless device 104, also includes non-volatile storage memory 614 for storing, for example, an application waiting to be executed (not shown) on the wireless device 104. The wireless device 104, in this example, also includes an optional local wireless link 616 that allows the wireless device 104 to directly communicate with another wireless device without using a wireless network (not shown).

The optional local wireless link 616, for example, is provided by Bluetooth, Zigbee, Infrared Data Access (IrDA) technologies, or the like. The optional local wireless link 616 also includes a local wireless link transmit/receive module 618 that allows the wireless device 104 to directly communicate with another wireless device such as wireless devices communicatively coupled to personal computers, workstations, and the like. In one embodiment, the local wireless link 616 is used to communicate with sensors 122 as discussed above. In another embodiment, the receiver 608 and the transmitter 610 are configured to communicate with the sensors 122.

The wireless device 104 of FIG. 6 further includes an audio output controller 620 that receives decoded audio output signals from the receiver 608 or the local wireless link transmit/receive module 618. The audio controller 620 sends the received decoded audio signals to the audio output conditioning circuits 622 that perform various conditioning functions. For example, the audio output conditioning circuits 622 may reduce noise or amplify the signal. A speaker 624 receives the conditioned audio signals and allows audio output for listening by a user. The audio output controller 620, audio output conditioning circuits 622, and the speaker 524 also allow for an audible alert to be generated notifying the user of a missed call, received messages, or the like. The wireless device 104 further includes additional user output interfaces 626, for example, a head phone jack (not shown) or a hands-free speaker (not shown).

The wireless device 104 also includes a microphone 628 for allowing a user to input audio signals into the wireless device 104. Sound waves are received by the microphone 628 and are converted into an electrical audio signal. Audio input conditioning circuits 630 receive the audio signal and perform various conditioning functions on the audio signal, for example, noise reduction. An audio input controller 632 receives the conditioned audio signal and sends a representation of the audio signal to the device controller 602.

The wireless device 104 also comprises a keyboard 634 for allowing a user to enter information into the wireless device 104. The wireless device 104 further comprises a camera 636 for allowing a user to capture still images or video images into memory 612. Furthermore, the wireless device 104 includes additional user input interfaces 638, for example, touch screen technology (not shown), a joystick (not shown), or a scroll wheel (not shown). In one embodiment, a peripheral interface (not shown) is also included for allowing the connection of a data cable to the wireless device 104. In one embodiment of the present invention, the connection of a data cable allows the wireless device 104 to be connected to a computer or a printer.

A visual notification (or indication) interface 640 is also included on the wireless device 104 for rendering a visual notification (or visual indication), for example, a sequence of colored lights on the display 644 or flashing one ore more LEDs (not shown), to the user of the wireless device 104. For example, a received multimedia message may include a sequence of colored lights to be displayed to the user as part of the message. Alternatively, the visual notification interface 640 can be used as an alert by displaying a sequence of colored lights or a single flashing light on the display 644 or LEDs (not shown) when the wireless device 104 receives a message, or the user missed a call.

The wireless device 104 also includes a tactile interface 642 for delivering a vibrating media component, tactile alert, or the like. For example, a multimedia message received by the wireless device 104, may include a video media component that provides a vibration during playback of the multimedia message. The tactile interface 642, in one embodiment, is used during a silent mode of the wireless device 104 to alert the user of an incoming call or message, missed call, or the like. The tactile interface 642 allows this vibration to occur, for example, through a vibrating motor or the like.

The wireless device 104 also includes a display 640 for displaying information to the user of the wireless device 104 and an optional Global Positioning System (GPS) module 646. The optional GPS module 646 determines the location and/or velocity information of the wireless device 104. This module 646 uses the GPS satellite system to determine the location and/or velocity of the wireless device 104. Alternative to the GPS module 646, the wireless device 104 may include alternative modules for determining the location and/or velocity of wireless device 104, for example, using cell tower triangulation and assisted GPS.

Exemplary Information Processing System

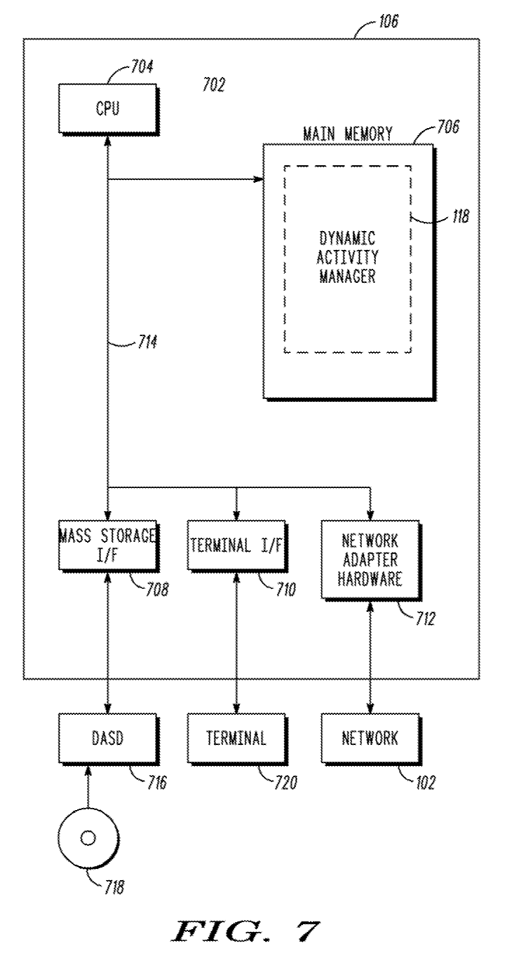

FIG. 7 is a block diagram illustrating a detailed view of the central server 106. It should be noted that the following discussion is also applicable to any information processing system communicatively coupled to the wireless device 104. Throughout the discussion of FIG. 7 the central server 106 is referred to as the “information processing system 106”. The information processing system 106, in one embodiment, is based upon a suitably configured processing system adapted to implement the exemplary embodiment of the present invention. Any suitably configured processing system is similarly able to be used as the information processing system 106 by embodiments of the present invention, for example, a personal computer, workstation, or the like.

The information processing system 106 includes a computer 702. The computer 702 has a processor 704 that is communicatively connected to a main memory 706 (e.g., volatile memory), non-volatile storage interface 708, a terminal interface 710, and a network adapter hardware 712. A system bus 714 interconnects these system components. The non-volatile storage interface 708 is used to connect mass storage devices, such as data storage device 716 to the information processing system 106. One specific type of data storage device is a computer readable medium such as a CD drive, which may be used to store data to and read data from a CD or DVD 718 or floppy diskette (not shown). Another type of data storage device is a data storage device configured to support, for example, NTFS type file system operations.

The main memory 706, in one embodiment, optionally includes the activity manager 118 as discussed above. Alternatively, the main memory 706 can include one or more components of the activity manager 118 discussed above. These components have not been shown in FIG. 7 for simplicity. Although shown as residing in the memory 606, these components can be implemented in hardware within the information processing system 106.

In one embodiment, the information processing system 106 utilizes conventional virtual addressing mechanisms to allow programs to behave as if they have access to a large, single storage entity, referred to herein as a computer system memory, instead of access to multiple, smaller storage entities such as the main memory 706 and data storage device 716. Note that the term “computer system memory” is used herein to generically refer to the entire virtual memory of the information processing system 106.

Although only one CPU 704 is illustrated for computer 702, computer systems with multiple CPUs can be used equally effectively. Embodiments of the present invention further incorporate interfaces that each includes separate, fully programmed microprocessors that are used to off-load processing from the CPU 704. Terminal interface 610 is used to directly connect one or more terminals 720 to computer 702 to provide a user interface to the computer 702. These terminals 620, which are able to be non-intelligent or fully programmable workstations, are used to allow system administrators and users to communicate with the thin client. The terminal 720 is also able to consist of user interface and peripheral devices that are connected to computer 702 and controlled by terminal interface hardware included in the terminal I/F 710 that includes video adapters and interfaces for keyboards, pointing devices, and the like.

An operating system, according to an embodiment, can be included in the main memory 706 and is a suitable multitasking operating system such as the Linux, UNIX, Windows XP, and Windows Server operating system. Embodiments of the present invention are able to use any other suitable operating system, or kernel, or other suitable control software. Some embodiments of the present invention utilize architectures, such as an object oriented framework mechanism, that allows instructions of the components of operating system (not shown) to be executed on any processor located within the client. The network adapter hardware 712 is used to provide an interface to the wireless communications network 102 or any other network. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 718, CD ROM, or other form of recordable media, or via any type of electronic transmission mechanism.

Process of Associating Contexts with an Activity

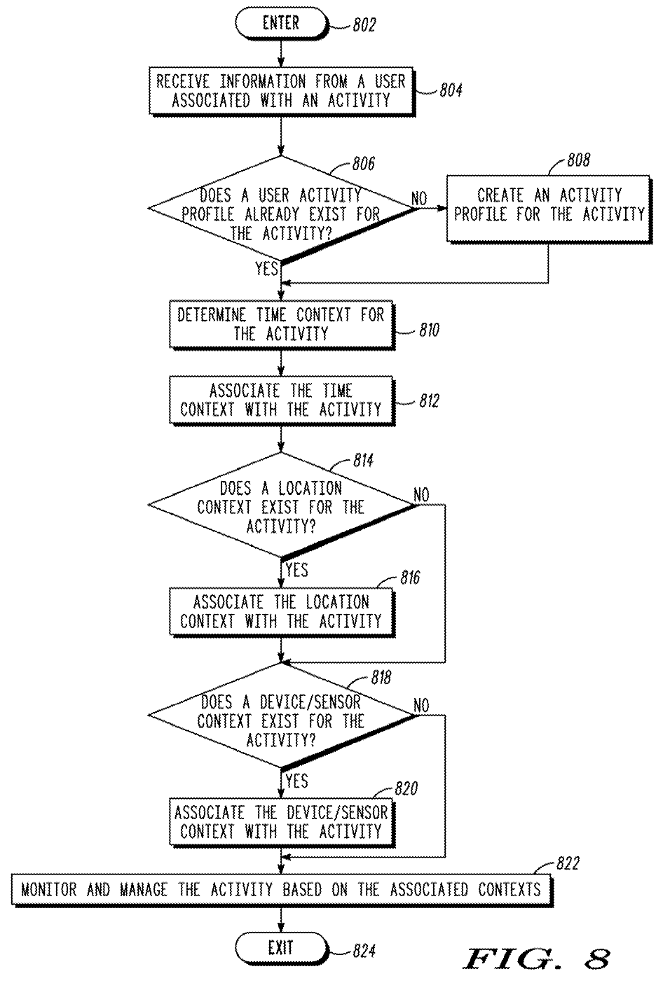

FIG. 8 is an operational flow diagram illustrating a process of associating at least one context with an activity. The operational flow diagram of FIG. 8 begins at step 802 and flows directly to step 804. The activity manager 118, at step 804, receives information from a user associated with an activity. For example, a user can enter information at a sensor, on an information processing system communicatively coupled to the wireless device 104, directly at the wireless device 104, or the like. Alternatively, a calendar entry can also trigger receipt of information associated with activity from user. For example, a user can enter an activity in a calendar and the activity manager 118 collects information associated with an activity based on the calendar entry.

The activity manager 118, at step 806, determines if a user activity profile already exists for the activity. If the result of this determination is negative, the activity manager 118, at step 808, creates an activity profile for the activity. The control then flows to step 810. If the result of this determination is positive, the activity manager 118, at step 810, determines the time context for the activity. The time context can be included within the activity profile 210, in a calendar event, or the like. The activity manager 118, at step 812, associates the time context with the activity. The activity manager 118, at step 814, determines if a location context exits for the activity. If the result of this determination is negative, the control flows to step 818. If the result of this determination is positive, the activity manager 118, at step 816, associates the location context with the activity. The activity manager 118, at step 818, determines if a device/sensor context exists for the activity. If the result of this determination is negative, the control flows to step 822. If the result of this determination is positive, the activity manager, at step 820, associates the device/sensor context with the activity. The activity manager 118, at step 822, monitors and manages the activity based on the associated contexts. The control flow then exits at step 824.

Process of Monitoring and Managing Lifestyle Activities Based on Contexts

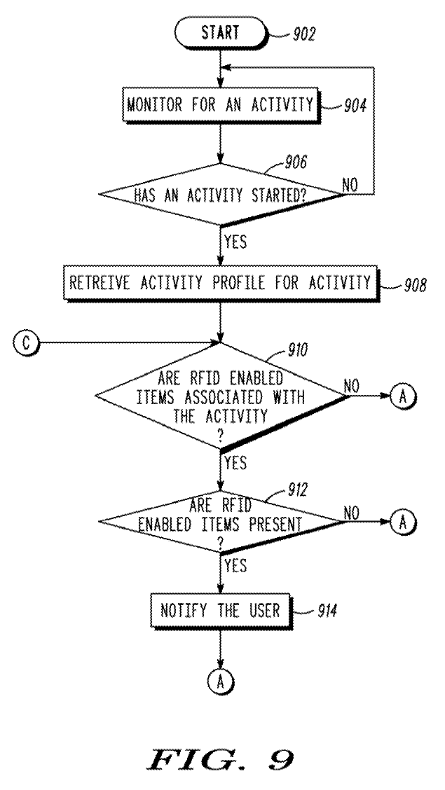

FIG. 9 to FIG. 11 are operational flow diagrams illustrating a process of monitoring and managing lifestyle activities based on contexts associated therewith. The operational flow diagram of FIG. 9 begins at step 902 and flows directly to step 904. The activity manager 118, at step 904, monitors for an activity. For example, the activity manager 118 can monitor a time context to determine if a starting time for an activity has occurred. The activity manager 118 can also monitor a location context associated with an activity to determine if the user is at a location where an activity is to take place.

The activity manager 118, at step 906, determines if an activity has started. If the result of this determination is negative, the activity manager 118 continues to monitor for an activity. If the result of this determination is positive, the activity manager 118, at step 908, retrieves an activity profile associated with that activity. The activity manager 118, at step 910, determines if RFID enabled items 120 are associated with the activity. If the result of this determination is negative, the control flows to entry point A of FIG. 9. If the result of this determination is positive, the activity manager 118, at step 912, detects if the RFID enabled items 120 are present. If the result of this determination is positive, the control flows to entry point A of FIG. 9. If the result of this determination is negative, the activity manager 118, at step 914, notifies the user of the missing RFID enabled items 120. Alternatively, the activity manager can also notify the user of present RFID enabled items 120. The control then flows to entry point A of FIG. 9.

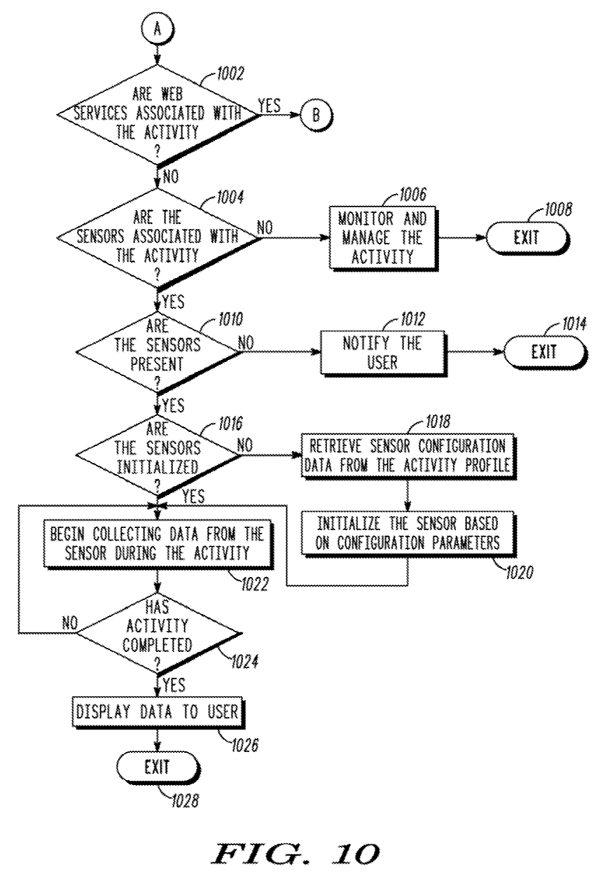

The control flows from entry point A in FIG. 10 directly to step 1002. The activity manager 118, at step 1002, determines if web services 124 are associated with the activity. If the result of this determination is positive, the control flows to entry point B of FIG. 10. If the result of this determination is negative, the activity manager 118, at step 1004, determines if sensors 122 are associated with the activity. If the result of this determination is negative, the activity manager 118, at step 1006, manages and monitors the activity based on the time context. The control flow then exits at step 1008.

If the result of this determination is positive, the activity manager 118, at step 1010, determines if the sensors 122 are present. If the result of this determination is negative, the activity manager 118, at step 1012, notifies the user of the missing sensors 124. The control flow then exits at step 1014. If the result of this determination is positive, the activity manager 118, at step 1016, determines if the sensors are initialized. If the result of this determination is negative, the activity manager 118, at step 1018, retrieves the configuration parameters associated with the sensors 122 from the activity profile 210. The activity manager 118, at step 1020, initializes the sensors 122 based on their associate configuration parameters. The control flows to step 1022.

If the result of this determination is positive, the activity manager 118, at step 1022, begins collecting data from the sensors 122 during the activity. The activity manager 118, at step 1024, determines if the activity has completed. If the result of this determination is negative, the activity manager 118 continues collecting data from the sensors 122. If the result of this determination is positive, the activity manager 118, at step 1026, displays the collected data to the user. The control flow then exits at step 1028.

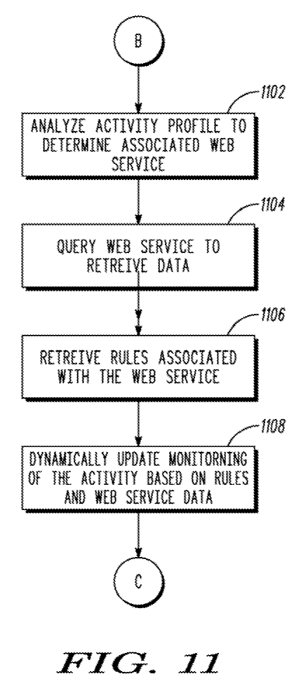

If the control flows to entry point B of FIG. 11, the activity manager 118, at step 1102, analyzes the activity profile 210 associated with the activity to determine the associated web services. The activity manager 118, at step 1104, queries the web service (s) 124 to retrieve data. Use rules, at step 1106, associated with the web services 124 are retrieved. For example, the user may have defined a rule that states if it is raining, the do not track RFID enabled sunglasses. The user can also have a rule that states if it is raining then do not monitor the activity until prompted. The activity manager 118, at step 1108, dynamically updates the monitoring and managing of the activity. The control then flows to entry point C of FIGS. 8 and 9, where the dynamic monitoring updates are applied. For example, even though RFID enabled items 120 or sensors 122 are associated with the activity, they may not be used or may be substituted based on the user rules associated with the web services 124.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless communication device, for monitoring lifestyle activities, the method comprising:
receiving a set of user activity identifiers associated with a set of user activities;
identifying at least one sensor assigned to each user activity in the set of user activities;
associating at least one user activity context with each user activity in the set of user activities;
monitoring for an occurrence of the at least one user activity context;
determining, based on the monitoring, whether the at least one user activity context has occurred; and
monitoring, in response to the at least one user activity context having occurred, each sensor assigned to the user activity associated with the at least one user activity context.

2. The method of claim 1, wherein in response to the at least one user activity context having occurred, collecting sensor output data of each and every sensor assigned to a user activity associated with the at least one user activity context that has occurred, the collected sensor output data representing a sensing profile of the at least one user activity context that has occurred.

3. The method of claim 1, wherein the at least one sensor comprises at least one of:
a radio frequency ID tag;
a heart rate monitor;
an electrical device capable of monitoring biometric measurements;
an electrical device capable of monitoring physiological measurement; and
a electrical device capable of monitoring athletic measurements.

4. The method of claim 1, further comprising:
determining if a set of RFID enabled items associated with the at least one user activity are present; and
notifying, in response to the at least one RFID enabled item not being present, a user of a missing RFID enabled item associated with the at least one user activity.

5. The method of claim 4, wherein the determining is performed prior to the at least one user activity context occurring.

6. The method of claim 1, wherein the at least one user activity context is one of:
a time domain context; and
a location context.

7. The method of claim 1, wherein the set of user activity identifiers is received from at least one calendar entry.

8. The method of claim 1, wherein if the at least one user activity context has occurred:
determining if each sensor assigned to the user activity is initialized;
in response to a sensor assigned to the user activity failing to be initialized,
retrieving a user activity profile associated with the user activity;
identifying configuration parameters associated with the sensor; and
initializing the sensor based on the configuration parameters.

9. The method of claim 1, wherein in response to the at least one user activity context having occurred:
determining if the user activity is associated with a web service; and
in response to the user activity being associated with a web service, querying the web service for subscribed to data;
retrieving a user activity profile associated with the user activity;
identifying monitoring rules associated with web service data; and
dynamically updating the monitoring of each sensor based on the rules associated with the web service data and the subscribed to data.

10. The method of claim 8, wherein the subscribed to data is based on the context associated with the user activity.

11. A wireless communication device, the wireless communication device comprising:
a memory;
a processor communicatively coupled to the memory; and
a dynamic activity manager communicatively coupled to the memory and the processor, the dynamic activity manager for:
receiving a set of user activity identifiers associated with a set of user activities;
identifying at least one sensor assigned to each user activity in the set of user activities;
associating at least one user activity context with each user activity in the set of user activities;
monitoring for an occurrence of the at least one user activity context;
determining, based on the monitoring, whether the at least one user activity context has occurred; and
monitoring, in response to the at least one user activity context having occurred, each sensor assigned to the user activity associated with the at least one user activity context.

12. The wireless communication device of claim 11, wherein the dynamic activity manager is further for:
in response to the at least one user activity context having occurred, collecting sensor output data of each and every sensor assigned to a user activity associated with the at least one user activity context that has occurred, the collected sensor output data representing a sensing profile of the at least one user activity context that has occurred.

13. The wireless communication device of claim 11, wherein the dynamic activity manager is further for:
determining if a set of RFID enabled items associated with the user activity are present; and
notifying, in response to the at least one RFID enabled item not being present, a user of a missing RFID enabled item associated with the user activity.

14. The wireless communication device of claim 11, wherein if the at least one user activity context has occurred, the dynamic activity manager is further for:
determining if each sensor assigned to the user activity is initialized;
in response to a sensor assigned to the user activity failing to be initialized,
retrieving a user activity profile associated with the user activity;
identifying configuration parameters associated with the sensor; and
initializing the sensor based on the configuration parameters.

15. The wireless communication device of claim 11, wherein in response to the at least one user activity context having occurred, the dynamic activity manger is further for:
determining if the user activity is associated with a web service; and
in response to the user activity being associated with a web service, querying the web service for subscribed to data;
retrieving a user activity profile associated with the user activity;
identifying monitoring rules associated with web service data; and
dynamically updating the monitoring of each sensor based on the rules associated with the web service data and the subscribed to data.

16. An information processing system for monitoring lifestyle activities, the information processing system comprising:
a memory;
a processor communicatively coupled to the memory; and
a dynamic activity manager communicatively coupled to the memory and the processor, the dynamic activity manager for:
receiving a set of user activity identifiers associated with a set of user activities;
identifying at least one sensor assigned to each user activity in the set of user activities;
associating at least one user activity context with each user activity in the set of user activities;
monitoring for an occurrence of the at least one user activity context;
determining, based on the monitoring, whether the at least one user activity context has occurred; and
monitoring, in response to the at least one user activity context having occurred, each sensor assigned to the user activity associated with the at least one user activity context.

17. The information processing system of claim 16, wherein in response to the at least one user activity context having occurred, the dynamic activity manager is further for:
collecting sensor output data of each and every sensor assigned to a user activity associated with the at least one user activity context that has occurred, the collected sensor output data representing a sensing profile of the at least one user activity context that has occurred.

18. The information processing system of claim 16, wherein the dynamic activity manager is further for:
determining if a set of RFID enabled items associated with the user activity are present; and
notifying, in response to the at least one RFID enabled item not being present, a user of a missing RFID enabled item associated with the user activity.

19. The information processing system of claim 16, wherein if the at least one user activity context has occurred, the dynamic activity manager is further for:
determining if each sensor assigned to the user activity is initialized; and
in response to a sensor assigned to the user activity failing to be initialized,
retrieving a user activity profile associated with the user activity;
identifying configuration parameters associated with the sensor; and
initializing the sensor based on the configuration parameters.

20. The information processing system of claim 16, wherein in response to the at least one user activity context having occurred, the dynamic activity manger is further for:
determining if the user activity is associated with a web service; and
in response to the user activity being associated with a web service, querying the web service for subscribed to data;
retrieving a user activity profile associated with the user activity;
identifying monitoring rules associated with web service data; and
dynamically updating the monitoring of each sensor based on the rules associated with the web service data and the subscribed to data.
